(19) United States
(12) Patent Application Publication
(10) Pub. No.: US 2010/0254357 A1
(43) Pub. Date: Oct. 7, 2010

(54) Method and System for Remotely Communicating Information to a Plurality of Devices Within a Femtocell Network

(76) Inventors: Charles Abraham, Los Gatos, CA (US); Xuemin Chen, Rancho Santa Fe, CA (US); Wael William Diab, San Francisco, CA (US); Vinko Erceg, Cardiff, CA (US); Victor Hou, LaJolla, CA (US); Jeyhan Karaoguz, Irvine, CA (US); Mark Kent, Vista, CA (US)

Correspondence Address: MCANDREWS HELD & MALLOY, LTD, 500 WEST MADISON STREET, SUITE 3400, CHICAGO, IL, 60661, US

(21) Appl. No.: 12/418,239

(22) Filed: Apr. 3, 2009

(51) Int. Cl. H04W 84/02; G06F 15/173

(52) U.S. Cl. 370/338; 709/223

(57) ABSTRACT

Aspects of a method and system for remotely communicating information to a plurality of devices within a femtocell network are provided. In this regard, a communication system may comprise a plurality of communication devices operable to communicate with one or more of a plurality of femtocells via one or more wireless connections and/or via one or more wired connections. The plurality of femtocells may be managed via a femtocell management entity. One of the plurality of communication devices may be operable to receive information from the femtocell management entity via one or more of the plurality of femtocells utilizing one or both of the one or more wireless connections and/or the one or more wired connections. One of the plurality of communication devices may be configured by utilizing the received information. The received information may comprise one or more of software, service profiles, device configuration data and/or synchronization data.

### CROSS-REFERENCE TO RELATED APPLICATIONS/INCORPORATION BY REFERENCE

Not Applicable

### FIELD OF THE INVENTION

Certain embodiments of the invention relate to communications. More specifically, certain embodiments of the invention relate to a method and system for remotely communicating information to a plurality of devices within a femtocell network.

### BACKGROUND OF THE INVENTION

A femtocell is a small base station that may be placed in a customer's residence or in a small business environment, for example. Femtocells may be utilized for off-loading macro radio network facilities, improving coverage locally in a cost-effective manner, and/or implementing home-zone services to increase revenue. Femtocells, like macro base stations, may be enabled to connect “standard” phones to a cellular provider's network by a physical broadband connection which may be a digital subscriber line (DSL) connection, a cable connection and/or fiber connection, for example. Since the traffic between a customer's premises femtocell equipment and the operator's network may be traversing a public network, the traffic may be prone to various risks.

Communication between femtocells and one or more cellular provider's networks enables operation in private and public areas. The capacity of a femtocell may be adequate to address a typical family use model supporting two to four simultaneous voice calls and/or data, for example.

An important characteristic of femtocells is their ability to control access. In an open access scenario, any terminal and/or subscriber of a cellular base station may be allowed to communicate with the femtocell. Accordingly, the femtocell usage may somewhat resemble that of a macrocellular system. In a closed access scenario, the femtocell may serve a limited number of terminals and/or subscribers that may be subscribed to a given cellular base station. In this regard, the cellular base station may be perceived as being deployed for private usage.

A regulatory issue with regard to femtocells is that they use licensed frequencies that radiate at a very low power in a controlled environment. It may be likely that they may not require a license from a local authority, as macrocellular base stations do. An additional regulatory issue may arise from the relationship between a femtocell operator and a broadband services operator. One possible scenario may include the broadband operator being unaware of the existence of a femtocell operator. Conversely, the broadband operator and femtocell operator may have an agreement or they may be the same operator, for example. Interference between femtocells may be an issue for femtocell deployments based on wideband technologies such as WCDMA, OFDM, for example, because initial operator deployments may use the same frequency for both the femtocell and the macrocellular networks or due to the proximity of femtocell base stations in dense urban areas

There are a plurality of design models for deployment and integration of femtocells, for example, an IP based Iu-b interface, a session initiation protocol (SIP) based approach using an Iu/A interface, use of unlicensed spectrum in a technique known as unlicensed mobile access (UMA) and/or use of IP multimedia subsystem (IMS) voice call continuity (VCC), for example.

In an Iu-b model based femtocell deployment approach, femtocells may be fully integrated into the wireless carrier's network and may be treated like any other remote node in a network. The Iu-b protocol may have a plurality of responsibilities, such as the management of common channels, common resources, and radio links along with configuration management, including cell configuration management, measurement handling and control, time division duplex (TDD) synchronization, and/or error reporting, for example. In Iu-b configurations, mobile devices may access the network and its services via the Node B link, and femtocells may be treated as traditional base stations.

In a SIP based femtocell deployment approach, a SIP client, embedded in the femtocell may be enabled to utilize SIP to communicate with the SIP-enabled mobile switching center (MSC). The MSC may perform the operational translation between the IP SIP network and the traditional mobile network, for example.

In a UMA based femtocell deployment approach, a generic access network (GAN) may offer an alternative way to access GSM and GPRS core network services over broadband. To support this approach, a UMA Network Controller (UNC) and protocols that guarantee secure transport of signaling and user traffic over IP may be utilized. The UNC may be enabled to interface into a core network via existing 3GPP interfaces, for example, to support core network integration of femtocell based services by delivering a standards based, scalable IP interface for mobile core networks.

In an IMS VCC based femtocell deployment approach, VCC may provide for a network design that may extend an IMS network to include cellular coverage and address the handoff process. The IMS VCC may be designed to provide seamless call continuity between cellular networks and any network that supports VoIP, for example. The VCC may also provide for interoperability between GSM, UMTS, and CDMA cellular networks and any IP capable wireless access network, for example. The IMS VCC may also support the use of a single phone number or SIP identity and may offer a broad collection of functional advantages, for example, support for multiple markets and market segments, provisioning of enhanced IMS multimedia services, including greater service personalization and control, seamless handoff between circuit-switched and IMS networks, and/or access to services from any IP device.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for remotely communicating information to a plurality of devices within a femtocell network, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating remotely communicating information to a plurality of devices within a femtocell network, in accordance with an embodiment of the invention.

FIG. 1B is a diagram illustrating another embodiment for remotely communicating information to a plurality of devices within a femtocell network, in accordance with an embodiment of the invention.

FIG. 1C is a block diagram of an exemplary femtocell, in accordance with an embodiment of the invention.

FIG. 2 is a diagram illustrating a geographic area comprising a plurality of femtocells managed via a management entity for remotely communicating information to a plurality of devices within a femtocell network, in accordance with an embodiment of the invention.

FIG. 3 is a flow chart illustrating exemplary steps for remotely communicating information to a plurality of devices within a femtocell network, in accordance with an embodiment of the invention.

FIG. 4 is a flow chart illustrating exemplary steps for remotely communicating information to a plurality of devices within a femtocell network via one or more wireless connections and/or one or more wired connections, in accordance with an embodiment of the invention.

### DETAILED DESCRIPTION OF THE INVENTION

Certain embodiments of the invention may be found in a method and system for remotely communicating information to a plurality of devices within a femtocell network. In various embodiments of the invention, a communication system may comprise a plurality of communication devices operable to communicate with one or more of a plurality of femtocells via one or more wireless connections and/or via one or more wired connections. The plurality of femtocells may be managed via a femtocell management entity. One of the plurality of communication devices may be operable to receive information from the femtocell management entity via one or more of the plurality of femtocells utilizing one or both of the one or more wireless connections and/or the one or more wired connections. One of the plurality of communication devices may be configured utilizing the received information. The received information may comprise one or more of software, service profiles, device configuration data and/or synchronization data.

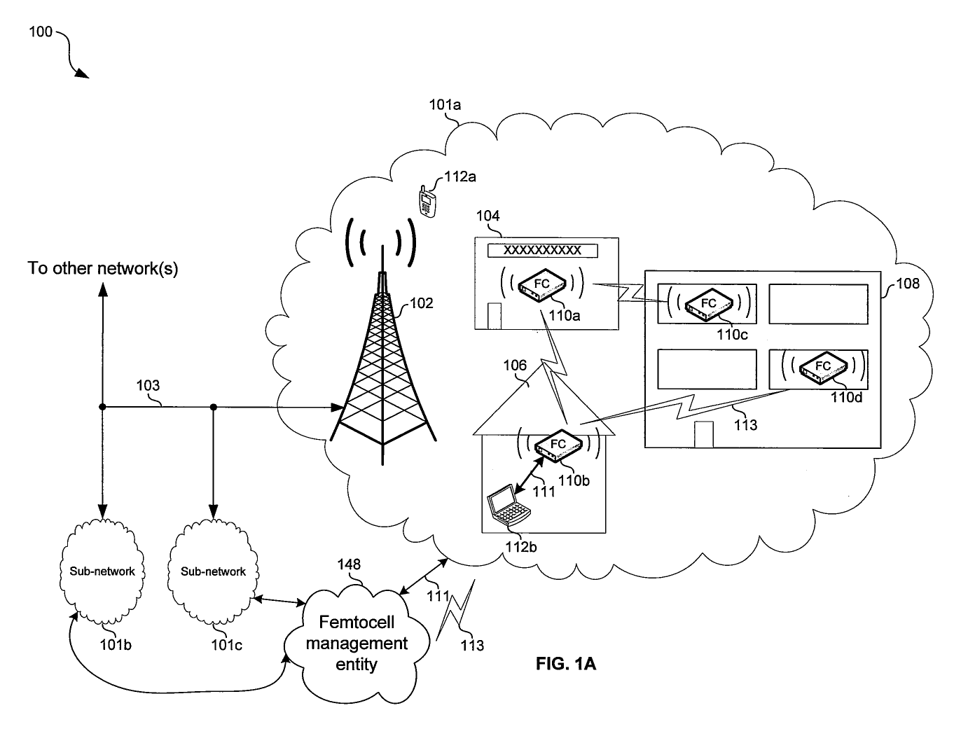

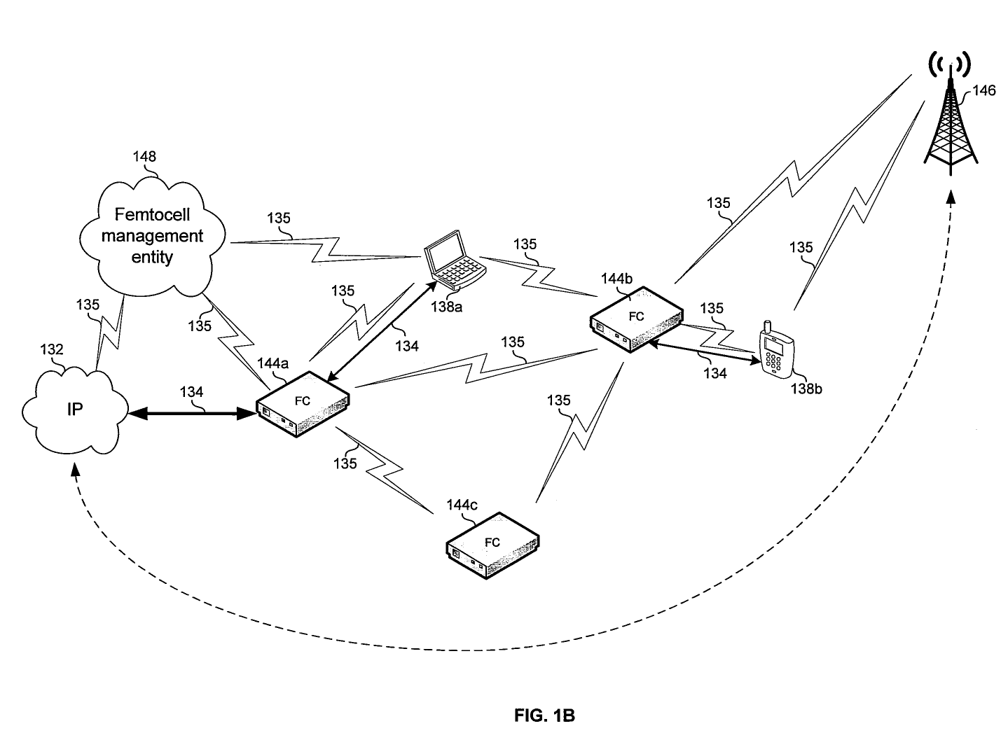

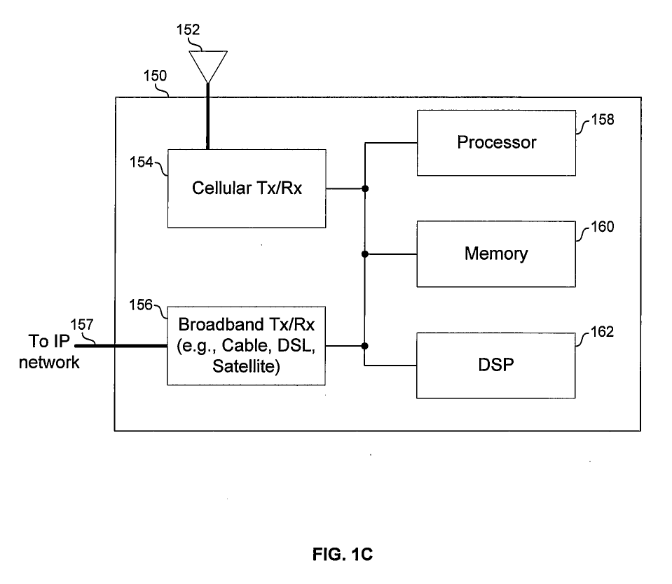

FIG. 1A is a diagram illustrating remotely communicating information to a plurality of devices within a femtocell network, in accordance with an embodiment of the invention. Referring to FIG. 1A, there is shown a cellular network 100 comprising cellular sub-networks 101a, 101b and 101c, and a femtocell management entity 148. The exemplary cellular sub-network 101a may comprise a base station 102, a plurality of femtocells 110a, 110b, 110c and 110d, which are collectively referred to herein as femtocells 110, cellular enabled communication devices 112a and 112b, which are collectively referred to herein as cellular enabled communication devices 112. The femtocells 110 may be installed in one or more commercial properties 104, one or more residential properties 106, and/or one or more multi-tenant properties 108.

The commercial properties 104 may comprise, for example, stores, restaurants, offices, and municipal buildings. The residential properties 106 may comprise, for example, single-family homes, home offices, and/or town-houses. Multi-tenant properties 108 may comprise residential and/or commercial tenants such as apartments, condos, hotels, and/or high rises.

The base station 102 may be operable to communicate data wirelessly utilizing one or more cellular standards such as IS-95, CDMA, GSM, TDMA, GPRS, EDGE, UMTS/WCDMA, TD-SCDMA, HSDPA, OFDM, extensions thereto, and/or variants thereof. “Data,” as utilized herein, may refer to any analog and/or digital information including but not limited to voice, Internet data, and/or multimedia content. Multimedia content may comprise audio and/or visual content comprising, video, still images, animated images, and/or textual content. The base station 102 may communicate with cellular enabled communication devices such as the cellular enabled communication devices 112. Exemplary cellular standards supported by the base station 102 may be specified in the International Mobile Telecomunnications-2000 (IMT-2000) standard and/or developed by the 3^{rd} generation partnership project (3GPP) and/or the 3^{rd} generation partnership project 2 (3GPP2). The base station 102 may communicate data amongst the various components of the sub-network 101a. Additionally, data communicated to and/or from the base station 102 may be communicated to sub-network 101b, sub-network 101c, and/or to one or more other networks (not shown) via one or more backhaul links 103. In this manner, data communicated to and/or from the base station 102 may be communicated to and/or from, other portions of the network 100 and/or other networks. Exemplary networks with which data may be communicated may comprise public switched telephone networks (PSTN) and/or IP networks such as the Internet or an intranet.

The femtocell management entity 148 may comprise suitable logic, circuitry, and/or code for managing operating parameters of one more femtocells 110. The femtocells 110 may each comprise suitable logic, circuitry, and/or code that may be operable to communicate wirelessly utilizing one or more cellular standards such as IS-95, CDMA, GSM, TDMA, GPRS, EDGE, UMTS/WCDMA, TD-SCDMA, HSDPA, OFDM, extensions thereto, and/or variants thereof. In this regard, the femtocells 110 may each communicate with cellular enabled communication devices such as the cellular enabled communication devices 112. Exemplary cellular standards supported by the femtocells 110 may be specified in the International Mobile Telecomunnications-2000 (IMT-2000) standard and/or developed by the 3^{rd} generation partnership project (3GPP) and/or the 3^{rd} generation partnership project 2 (3GPP2). Additionally, the femtocells 110 may each comprise suitable logic, circuitry, and/or code that may be operable to communicate over an IP network (not shown in FIG. 1A).

The cellular enabled communication devices 112 may each comprise suitable logic, circuitry, and/or code that may be operable to communicate utilizing one or more cellular standards. In this regard, the cellular enabled communication devices 112 may each be operable to transmit and/or receive data via the cellular network 100. Exemplary cellular enabled communication devices may comprise laptop computers, mobile phones, and personal media players, for example. The cellular enabled communication devices 112 may be enabled to receive, process, and present multimedia content and may additionally be enabled run a network browser or other applications for providing Internet services to a user of the cellular enabled device 112. For example, the cellular enabled device 112b may be a laptop computer and may comprise a broadband wireless connection 113 and a broadband wired connection 111.

The cellular enabled communication devices 112 may gain access to the cellular network 100 and/or to other communication networks via cellular communications with the base station 102 and the femtocells 110. In this regard, in instances that a reliable connection may be established between the base station 102 and a cellular enabled communication device 112, the data may be communicated between the cellular enabled communication device 112 and the base station 102. Alternatively, in instances that a reliable connection may be established between a femtocell 110 and a cellular enabled communication device 112, data may be communicated between the cellular enabled communication device 112 and the femtocell 110.

In accordance with an embodiment of the invention, the cellular enabled communication device 112b may be operable to receive information from the femtocell management entity 148 via one or more of the plurality of femtocells, for example, the femtocell 110b utilizing the one or more wired connections 111. The communication device 112b may be operable to configure itself utilizing the received information. The communication device 112b may be operable to receive at least a portion of the information from the femtocell management entity 148 via one or more of the plurality of femtocells, for example, the femtocell 110b utilizing the one or more wireless connections 113 and receive a remaining portion of the information from the femtocell management entity 148 via one or more of the plurality of femtocells, for example, the femtocell 110b utilizing the one or more wired connections 111.

In this regard, access by a cellular enabled communication device to a femtocell may comprise an ability of the cellular enabled communication device 112 to establish one or more cellular communication channels with the femtocell. The cellular communication channels between the cellular enabled communication device 112 and the femtocell 110 may enable the cellular enabled communication device 112 to exchange data with, for example, other cellular enabled communication devices, landline telephones, and/or network nodes such as fileservers, which may be communicatively coupled to a local area network and/or the Internet. Accordingly, the femtocells 110 may extend the cellular coverage area in the sub-network 101a. In particular, the femtocells 110 may extend or improve cellular coverage indoors or locations out of range of a base-station.

In operation, one of the communication devices, for example, the communication device 112b may be operable to receive information from the femtocell management entity 148 via one or both of the one or more wireless connections 113 and/or one or more wired connections 111. The received information may comprise one or more of software, service profiles, device configuration data and/or synchronization data, for example. Notwithstanding, the invention may not be so limited and other types of data may be received by the communication device without limiting the scope of the invention. The communication device 112b may be operable to synchronize the communication device 112b with one or more applications and/or services based on the received synchronization data.

FIG. 1B is a diagram illustrating another embodiment for remotely communicating information to a plurality of devices within a femtocell network, in accordance with an embodiment of the invention. Referring to FIG. 1B, there is shown a femtocell management entity 148, a plurality of femtocells 144a, 144b and 144c, cellular enabled communication devices 138a and 138b, collectively referred to herein as cellular enabled communication devices 138, and base station 146. The femtocell 144a may be communicatively coupled to an IP network 132 and the communication device 138a via a wired connection 134.

The base station 146 may be similar to or the same as the base station 102 described with respect to FIG. 1A, for example. The cellular enabled communication devices 138 may be similar to or the same as the cellular enabled communication devices 112 described with respect to FIG. 1A, for example. The femtocells 144a, 144b and 144c may be similar to or the same as the femtocells 110 described with respect to FIG. 1A, for example.

The IP network 132 may comprise one or more network devices and/or network links operable to transmit and/or receive IP packets. The IP network 132 may provide access to the Internet and/or one or more private networks. The wired connection 134 may comprise a broadband link such as a digital subscriber line (DSL), a T1/E1 line, a cable television infrastructure, a satellite television infrastructure, fiber link, and/or a satellite broadband Internet link. The wired connection 134 may comprise one or more optical, wired, and/or wireless links.

The cellular enabled device 138a and the cellular enabled device 138b may communicate via the femtocells 144a, 144b and 144c, the base station 146, and the IP network 132. For example, the cellular enabled device 138a may transmit data to the femtocell 144a utilizing one or more cellular standards. The femtocell 144a may packetize the data into one or more IP packets and the IP packets may be further encapsulated, encoded, modulated, or otherwise processed. The IP packets may then be routed via the IP network 132 to the base station 146. In some instances, the base station 146 may utilize IP backloading and the IP packets may be conveyed to the base station 146. In other instances, the IP packets may be transcoded via one or more network elements (not shown in FIG. 1B) to a format supported by the base station 146. The data may then be extracted from the IP packets, transcoded to a format suitable for cellular transmission, and subsequently transmitted to the cellular enabled device 138b. In accordance with an embodiment of the invention, the cellular enabled device 138a may be a laptop computer and may comprise a broadband wireless connection 135 and a broadband wired connection 134.

The plurality of communication devices 138a and 138b may be operable to communicate with one or more of the plurality of femtocells, for example, femtocells 144a, 144b and 144c via one or more wireless connections 135 and/or via one or more wired connections 134.

In operation, one of the plurality of communication devices, for example, communication device 138a may be operable to receive information from the femtocell management entity 148 via one or both of the one or more wireless connections 135 and/or one or more wired connections 134. The communication device 138a may be operable to configure itself utilizing the received information from the femtocell management entity 148. The communication device 138a may be operable to receive the information from the femtocell management entity 206 via one or more of the plurality of femtocells, for example, femtocell 144a or 144b. The communication device 138a may be operable to wirelessly receive the information from the femtocell management entity 148 via one or more of the plurality of femtocells, for example, femtocell 144a utilizing the one or more wireless connections 135. The communication device 138a may be operable to receive the information from the femtocell management entity 148 via one or more of the plurality of femtocells, for example, femtocell 144a utilizing the one or more wired connections 134. The communication device 138a may be operable to receive at least a portion of the information from the femtocell management entity 148 via one or more of the plurality of femtocells, for example, the femtocell 144a utilizing the one or more wireless connections 135 and receive a remaining portion of the information from the femtocell management entity 148 via one or more of the plurality of femtocells, for example, the femtocells 144a and/or 144b utilizing the one or more wired connections 135.

The received information may comprise one or more of software, service profiles, device configuration data and/or synchronization data, for example. Notwithstanding, the invention may not be so limited and other types of data may be received by the communication device without limiting the scope of the invention. The communication device 138a may be operable to synchronize itself with one or more applications and/or services based on the received synchronization data. The one or more wireless connections 135 may be operable to convey the information wirelessly utilizing one or more standards comprising IS-95, CDMA, GSM, TDMA, GPRS, EDGE, UMTS, WCDMA, TD-SCDMA, OFDM and/or HSDPA cellular standards.

In accordance with another embodiment of the invention, one or more of the plurality of femtocells, for example, femtocell 144a may be operable to buffer the received information. The femtocell 144a may be operable to communicate the buffered received information to the communication device 138a at a particular time, for example, during off-peak hours. The communication device 138a may be operable to receive the information upon installing and/or powering up of one or both of the communication device 138a and/or one or more of the plurality of femtocells, for example, femtocell 144a. The communication device 138a may be operable to receive the information upon command from a network administrator, for example, the femtocell management entity 148. The communication device 138a may be operable to receive the information when the communication device 138a is within a range of one or more of the plurality of femtocells, for example, femtocell 144a.

FIG. 1C is a block diagram of an exemplary femtocell, in accordance with an embodiment of the invention. Referring to FIG. 1C, there is shown a femtocell 150 comprising an antenna 152, a cellular transmitter and/or receiver (Tx/Rx) 154, a broadband transmitter and/or receiver (Tx/Rx) 156, a processor 158, a memory 160, and a digital signal processor (DSP) 162. The femtocell 150 may be similar to or the same as the femtocells 110 described with respect to FIG. 1B. The femtocell 150 may be part of a mesh network of interconnected femtocells.

The antenna 152 may be suitable for transmitting and/or receiving cellular signals. Although a single antenna is illustrated, the invention may not be so limited. In this regard, the cellular Tx/Rx 154 may utilize a common antenna for transmission and reception, or may utilize different antennas for transmission and reception, and/or may utilize a plurality of antennas for transmission and/or reception.

The cellular Tx/Rx 154 may comprise suitable logic circuitry and/or code that may be operable to transmit and/or receive voice and/or data utilizing one or more cellular standards. The cellular Tx/Rx 154 may be operable to perform amplification, down-conversion, filtering, demodulation, and analog to digital conversion of received cellular signals. The cellular Tx/Rx 154 may be operable to perform amplification, up-conversion, filtering, modulation, and digital to analog conversion of transmitted cellular signals. The cellular Tx/Rx 154 may support communication over a plurality of communication channels utilizing time division multiple access (TDMA) and/or code division multiple access (CDMA). Exemplary cellular standards supported by the femtocells 110 may be specified in the International Mobile Telecomunnications-2000 (IMT-2000) standard developed by the 3^{rd} generation partnership project (3GPP) and/or the 3^{rd} generation partnership project 2 (3GPP2). The cellular Tx/Rx 154 may be operable to transmit and/or receive on one or more frequencies and/or channels. One or more of the frequencies and/or one or more of the channels on which the cellular Tx/Rx 154 receives and/or transmits may be configured via one or more control signals from the processor 158, memory 160, and/or the DSP 162. The cellular Tx/Rx 154 may also comprise a received signal strength indicator for characterizing an environment in which the femtocell 150 resides.

The broadband Tx/Rx 156 may comprise suitable logic, circuitry, and/or code that may be operable to transmit voice and/or data in adherence to one or more broadband standards. The broadband Tx/Rx 156 may be operable to perform amplification, down-conversion, filtering, demodulation, and analog to digital conversion of received signals. The broadband Tx/Rx 156 may be operable to perform amplification, up-conversion, filtering, modulation, and digital to analog conversion of transmitted signals. In various exemplary embodiments of the invention, the broadband Tx/Rx 156 may transmit and/or receive voice and/or data over the link 157 which may be a T1/E1 line, optical fiber, DSL, cable television infrastructure, satellite broadband internet connection, satellite television infrastructure, and/or Ethernet. In various exemplary embodiments of the invention, data received via the broadband Tx/Rx 156 may be conveyed to the processor 158, memory 160, and/or the DSP 162 and may be utilized to control one or more frequencies and/or channels on which the cellular Tx/Rx 154 transmits and/or receives.

The processor 158 may comprise suitable logic, circuitry, and/or code that may enable processing data and/or controlling operations of the femtocell 150. In this regard, the processor 158 may be enabled to provide control signals to the various other blocks comprising the femtocell 150. The processor 158 may also control data transfers between various portions of the femtocell 150. Additionally, the processor 158 may enable execution of applications programs and/or code. In various embodiments of the invention, the applications, programs, and/or code may enable, for example, parsing, transcoding, or otherwise processing data. In various embodiments of the invention, the applications, programs, and/or code may enable, for example, configuring or controlling operation of the cellular Tx/Rx 154, the broadband Tx/Rx 156, the DSP 162, and/or the memory 160. In various embodiments of the invention, the applications, programs, and/or code may enable detecting interference and/or controlling cellular one or more frequencies and/or one or more channels on which the cellular Tx/Rx 154 transmits and/or receives. The processor 158 may be operable to buffer the received information in the memory 160. The processor 158 may be operable to communicate the buffered received information to the communication device 138a at a particular time, for example, during off-peak hours.

The processor 158 may be operable to communicate the information upon installing and/or powering up of one or both of the communication device 138a and/or one or more of the plurality of femtocells, for example, femtocell 150. The processor 158 may be operable to communicate the information upon command from a network administrator of, for example, the femtocell management entity 148. The processor 158 may be operable to communicate the information when the communication device 138a is within a range of one or more of the plurality of femtocells, for example, femtocell 150.

The memory 160 may comprise suitable logic, circuitry, and/or code that may enable storing the received information. The memory 160 may be operable to enable storage or programming of information that includes parameters and/or code that may effectuate the operation of the femtocell 150. The parameters may comprise configuration data and the code may comprise operational code such as software and/or firmware, but the information need not be limited in this regard. Moreover, the parameters may include adaptive filter and/or block coefficients. Additionally, the memory 160 may buffer or otherwise store received data and/or data to be transmitted. In various embodiments of the invention, the memory 160 may comprise one or more look-up tables utilized for determining cellular devices within a coverage area of the femtocell 150. In various embodiments of the invention, the memory 160 may comprise one or more look-up tables or other data structures which may comprise information controlling one or more frequencies and/or one or more channels on which the cellular Tx/Rx 154 transmits and/or receives.

The DSP 162 may comprise suitable logic, circuitry, and/or code operable to process audio and/or video signals. In various embodiments of the invention, the DSP 162 may encode, decode, modulate, demodulate, encrypt, and/or decrypt voice and/or data signals. In this regard, the DSP 162 may be operable to perform computationally intensive processing of voice and/or data signals. In various embodiments of the invention, the DSP 162 may be operable to detect interference and/or control one or more frequencies and/or one or more channels on which the cellular Tx/Rx 154 transmits and/or receives. The DSP 162 may be operable to perform, for example, fast Fourier transform analysis (FFT) of received signals to characterize an environment in which the femtocell 150 resides.

The one or more frequencies and/or channels on which the cellular Tx/Rx 154 may transmit and/or receive may also be determined, at least in part, based on data received via the broadband Tx/Rx 156. In this regard, other femtocells and/or base stations may characterize the environment in which they are operating and may communicate results of those characterizations over, for example, an IP network to which the femtocell 150 is communicatively coupled. In various embodiments of the invention, characterizing an environment may comprise measuring one or more parameters, such as measuring signal strengths on one or more frequencies and/or channels to determine potential interference with other installed femtocells, measuring power levels, measuring directionality of antennas and communicating the measured parameters to a femtocell management entity 148 for processing. In this manner, signals which may interfere with cellular communications with the femtocell 150 may be detected. The frequencies of operation, power levels and directionality of antennas may be dynamically communicated to the cellular enabled communication devices during operation. In accordance with an embodiment of the invention, information such as a list of locations of femtocells within a vicinity of a particular cellular enabled communication device, the directionality of antennas of the femtocells, the power levels of the femtocells and the operating frequencies of the femtocells may be communicated as real time updates to the cellular enabled communication device.

In operation, information may be exchanged, via the broadband Tx/Rx 156, between the femtocell 150 and a femtocell management entity 148. The exchanged information may be communicated utilizing, for example, the Internet Protocol (IP). The exchanged information may enable managing access to the femtocell 150 by one or more cellular enabled communication devices. Information may be exchanged between the femtocell 150 and the femtocell management entity 148 via the broadband TxRx 156. The information from the femtocell management entity may update one or more tables, lists, databases, or other data structures within the femtocell 150 that may determine permissions and/or track usage and/or billing for cellular enabled communication devices.

In some embodiments of the invention, a cellular enabled communication device may connect to the femtocell management entity 148 via a reserved channel provided by the cellular Tx/Rx 154. In this regard, data destined for the femtocell management entity from a cellular communication device may be received at the cellular Tx/Rx 154 which may down-convert, de-capsulate, and/or otherwise process the data. Additionally, the processor 158, memory 160, and/or DSP 162 may process the data prior to conveying the data to the broadband Tx/Rx 156. The broadband Tx/Rx 156 may then encapsulate, up-convert, and/or otherwise process the data and transmit the data to the femtocell management entity 148. Similarly, data destined for a cellular communication device from the femtocell management entity 148 may be received at the broadband Tx/Rx 156 which may down-convert, de-capsulate, and/or otherwise process the data. Additionally, the processor 158, memory 160, and/or DSP 162 may process the data prior to conveying the data to the cellular Tx/Rx 154. The cellular Tx/Rx 154 may then encapsulate, up-convert, and/or otherwise process the data and transmit the data to the cellular enabled communication device.

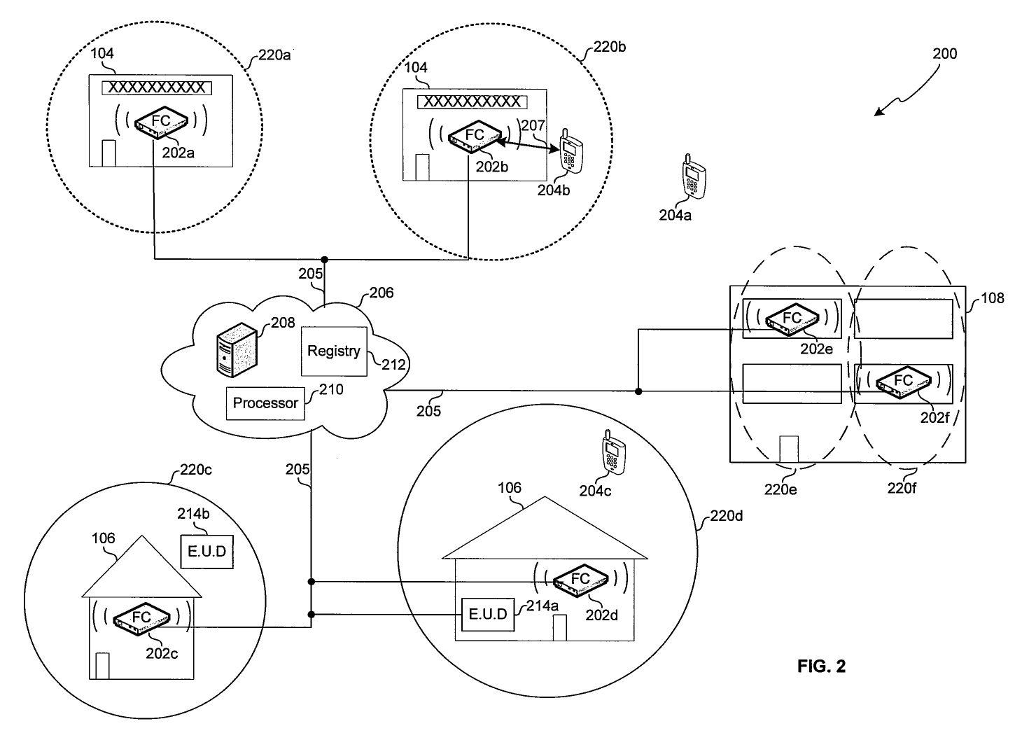

FIG. 2 is a diagram illustrating a geographic area comprising a plurality of femtocells managed via a management entity for remotely communicating information to a plurality of devices within a femtocell network, in accordance with an embodiment of the invention. Referring to FIG. 2, there is shown a communication system 200. The communication system 200 may comprise a plurality of commercial properties 104, residential properties 106, multi-tenant properties 108, a plurality of femtocells 202a, 202b, 202c, 202d, 202e and 202f, a plurality of cellular enabled communication devices 204a, 204b and 204c, end-user communication devices 214a and 214b, and a femtocell management entity 206.

The commercial properties 104, the residential properties 106, and the multi-tenant properties 108 may be substantially as described with respect to FIG. 1A. The cellular enabled communication devices 204a, 204b, and 204c may be similar to or the same as the cellular enabled communication devices 112a and 112b (FIG. 1A) and/or 138a and 138b (FIG. 1B). Exemplary cellular enabled communication devices comprise cell phones and laptops with a cellular data card. In some instances, the cellular enabled communication devices 204a, 204b, and 204c may be enabled to communicate with the femtocell management entity 206.

Each of the end-user communication devices 214a and 214b may comprise one or more of a cellular enabled communication device, similar to or the same as the devices 204a, 204b, and 204c, a wireless communication device such as a Bluetooth and/or Wi-Fi enabled device, and/or a wired communication device such as a computer with an Ethernet port. The end-user communication device 214a and 214b may be operable to communicate with the femtocell management entity 206.

The plurality of femtocells 202a, 202b, 202c, 202d, 202e and 202f, which are collectively referred to as femtocells 202, may be similar to or the same as the femtocells 110 (FIG. 1A), 144 (FIG. 1B), and/or 150 (FIG. 1C). The femtocells 202 may each be enabled to communicate with the femtocell management entity 206 via, for example, an IP connection. Each of the plurality of femtocells 202a, 202b, 202c, 202d, 202e and 202f may have a range of operation. For example, the femtocell 202a may be operable in a range 220a, the femtocell 202b may be operable in a range 220b, femtocell 202c may be operable in a range 220c, femtocell 202d may be operable in a range 220d, femtocell 202e may be operable in a range 220e, and femtocell 202f may be operable in a range 220f respectively.

The plurality of femtocells 202a, 202b, 202c, 202d, 202e and 202f may be established via the femtocell management entity 206. The femtocell management entity 206 may comprise suitable logic, circuitry, and/or code for managing operating parameters of one more installed femtocells 202a, 202c, 202d, 202e and 202f. In various embodiments of the invention, the femtocell management entity 206 may comprise an application specific device or plurality of devices. Alternatively, the femtocell management entity 206 may reside on and/or be enabled by one or more servers 208, a processor 210 and a registry 212, which may manage various parameters of communication channels over which the femtocells 202 may communicate. For example, the femtocell management entity 206 may comprise one or more web pages, databases, and/or web based applications which may be accessed via an IP network. In determining values for the various parameters, the femtocell management entity 206 may utilize feedback received from the femtocells 202. After determining the parameter values, the femtocell management entity 206 may communicate the determinations to the femtocells 202.

The communication system 200 may comprise a plurality of communication devices, for example, a plurality of cellular enabled communication devices 204a, 204b and 204c, and end-user communication devices 214a and 214b 204a, 204b, 204c, operable to communicate with one or more of a plurality of femtocells, for example, femtocells 202a, 202b, 202c, 202d, 202e and 202f and a femtocell management entity 206 that may coordinate operation of the plurality of femtocells, for example, femtocells 202a, 202b, 202c, 202d, 202e and 202f. The plurality of communication devices, for example, a plurality of cellular enabled communication devices 204a, 204b and 204c, and end-user communication devices 214a and 214b 204a, 204b, 204c, may be operable to communicate with one or more of the plurality of femtocells, for example, femtocells 202a, 202b, 202c, 202d, 202e and 202f via one or more wireless connections 205 and/or via one or more wired connections 207.

One of the plurality of communication devices, for example, communication device 204b may be operable to receive information from the femtocell management entity 206 via one or both of the one or more wireless connections 205 and/or one or more wired connections 207. The communication device 204b may be operable to configure one of the plurality of communication devices, for example, the communication device 204b utilizing the received information. The communication device 204b may be operable to receive the information from the femtocell management entity 206 via one or more of the plurality of femtocells, for example, femtocell 202b. The communication device 204b may be operable to wirelessly receive the information from the femtocell management entity 206 via one or more of the plurality of femtocells, for example, femtocell 202b utilizing the one or more wireless connections 205. The communication device 204b may be operable to receive the information from the femtocell management entity 206 via one or more of the plurality of femtocells, for example, femtocell 202b utilizing the one or more wired connections 207. The communication device 204b may be operable to receive at least a portion of the information from the femtocell management entity 206 via one or more of said plurality of femtocells, for example, femtocell 202b utilizing the one or more wireless connections 205 and receive a remaining portion of the information from the femtocell management entity 206 via one or more of the plurality of femtocells, for example, femtocell 202b utilizing the one or more wired connections 207.

The received information may comprise one or more of software, service profiles, device configuration data and/or synchronization data, for example. Notwithstanding, the invention may not be so limited and other types of data may be received by the communication device without limiting the scope of the invention. The communication device 204b may be operable to synchronize the communication device 204b with one or more applications and/or services based on the received synchronization data. The one or more wireless connections 205 may be operable to convey the information wirelessly utilizing one or more standards comprising IS-95, CDMA, GSM, TDMA, GPRS, EDGE, UMTS, WCDMA, TD-SCDMA, OFDM and/or HSDPA cellular standards.

In accordance with another embodiment of the invention, one or more of the plurality of femtocells, for example, femtocell 202b may be operable to buffer the received information in the memory 160. The femtocell 202b may be operable to communicate the buffered received information to the communication device 204b at a particular time, for example, during off-peak hours. The communication device 204b may be operable to receive the information upon installing and/or powering up of one or both of the communication device 204b and/or one or more of the plurality of femtocells, for example, femtocell 202b. The communication device 204b may be operable to receive the information upon command from a network administrator, for example, the femtocell management entity 206. The communication device 204b may be operable to receive the information when the communication device 204b is within a range 220b of one or more of the plurality of femtocells, for example, femtocell 204b.

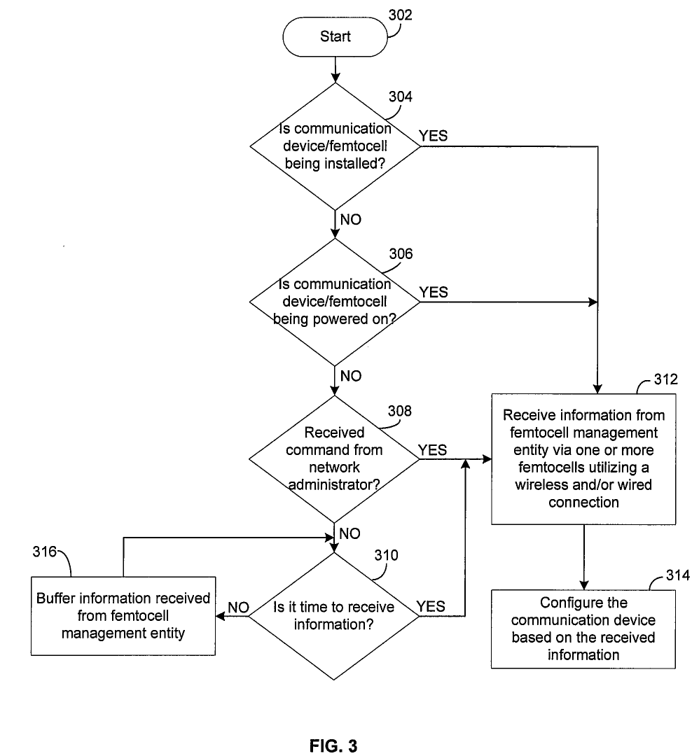

FIG. 3 is a flow chart illustrating exemplary steps for remotely communicating information to a plurality of devices within a femtocell network, in accordance with an embodiment of the invention. Referring to FIG. 3, exemplary steps may begin at step 302. In step 304, it may be determined whether a communication device and/or one or more of a plurality of femtocells operable to communicate with the communication device is being installed. If the communication device and/or one or more of the plurality of femtocells is being installed, control passes to step 312. In step 312, the communication device may be operable to receive information from the femtocell management entity 148 via one or more of the plurality of the femtocells utilizing one or more wireless connections and/or via one or more wired connections. In step 314, the communication device may be operable to utilize the received information to configure itself. The received information may comprise one or more of software, service profiles, device configuration data and/or synchronization data, for example.

If the communication device and/or one or more of the plurality of femtocells is not being installed control passes to step 306. In step 306, it may be determined whether a communication device and/or one or more of a plurality of femtocells operable to communicate with the communication device is being powered on. If the communication device and/or one or more of the plurality of femtocells is being powered on, control passes to step 312. If the communication device and/or one or more of the plurality of femtocells is not being powered on, control passes to step 308.

In step 308, it may be determined whether a command has been received from a network administrator, for example, the femtocell management entity 148 to communicate the received information to the communication device. If a command has been received from a network administrator to communicate the received information to the communication device, control passes to step 312. If no command has been received from a network administrator to communicate the received information to the communication device, control passes to step 310.

In step 310, it may be determined whether it is time to communicate the received information from the femtocell management entity 148 to the communication device. The time may be set by the femtocell, or may be set by the femtocell management entity 148, or may be set by the communication device, for example. If it is time to communicate the received information from the femtocell management entity 148 to the communication device, control passes to step 312. If it is not yet time to communicate the received information from the femtocell management entity 148 to the communication device, control passes to step 316. In step 316, the femtocell may be operable to buffer the received information in memory. Control then returns to step 310.

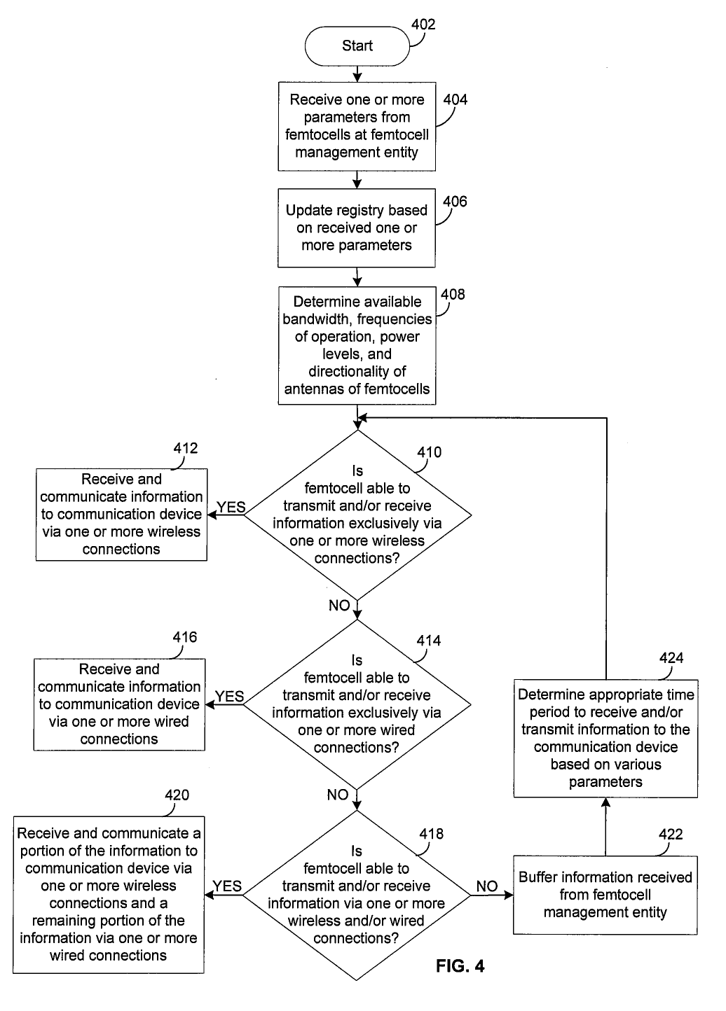

FIG. 4 is a flow chart illustrating exemplary steps for remotely communicating information to a plurality of devices within a femtocell network via one or more wireless connections and/or one or more wired connections, in accordance with an embodiment of the invention. Referring to FIG. 4, exemplary steps may begin at step 402. In step 404, a femtocell management entity 148 may receive one or more parameters, such as potential interference, power levels, location, associated communication devices, and/or directionality of antennas from one or more femtocells in the femtocell network. In step 406, a registry at the femtocell management entity 148 may be dynamically updated based on the received one or more parameters. In step 408, the femtocell management entity 148 may be operable to determine the available bandwidth of operation, potential interference among the femtocells, power levels, directionality of antennas, and frequencies of operation of the femtocells based on the received one or more parameters.

In step 410, it may be determined whether the femtocell may be operable to receive and/or transmit information to the communication device exclusively via one or more wireless connections. If the femtocell is operable to receive and/or transmit information to the communication device exclusively via one or more wireless connections, control passes to step 412. In step 412, the femtocell may be operable to receive and/or transmit information to the communication device exclusively via one or more wireless connections. If the femtocell is not operable to receive and/or transmit information to the communication device exclusively via one or more wireless connections, control passes to step 414.

In step 414, it may be determined whether the femtocell may be operable to receive and/or transmit information to the communication device exclusively via one or more wired connections. If the femtocell is operable to receive and/or transmit information to the communication device exclusively via one or more wired connections, control passes to step 416. In step 416, the femtocell may be operable to receive and/or transmit information to the communication device exclusively via one or more wired connections. If the femtocell is not operable to receive and/or transmit information to the communication device exclusively via one or more wired connections, control passes to step 418.

In step 418, it may be determined whether the femtocell may be operable to receive and/or transmit information to the communication device via one or more wireless connections and/or one or more wired connections. If the femtocell is operable to receive and/or transmit information to the communication device via one or more wireless connections and/or one or more wired connections, control passes to step 420. In step 420, the femtocell may be operable to receive and/or transmit a portion of the information to the communication device via one or more wireless connections and receive and/or transmit a remaining portion of the information to the communication device via one or more wired connections. If the femtocell is not operable to receive and/or transmit information to the communication device via one or more wireless connections and/or one or more wired connections, control passes to step 422. In step 422, the femtocell may be operable to buffer the received information in memory. In step 424, the femtocell may be operable to determine an appropriate time period to communicate the information to the communication device based on time of day, for example, peak or off-peak hours, cost of transmitting and/or receiving information to the communication device, location of the communication device with respect to the femtocell, available bandwidth of the femtocell, and potential interference of the femtocell with the communication device. Control then returns to step 410.

In accordance with an embodiment of the invention, a method and system for remotely communicating information to a plurality of devices within a femtocell network may comprise a communication system 200. The communication system 200 may comprise a plurality of communication devices, for example, a plurality of cellular enabled communication devices 204a, 204b and 204c, and end-user communication devices 214a and 214b 204a, 204b, 204c, operable to communicate with one or more of a plurality of femtocells, for example, femtocells 202a, 202b, 202c, 202d, 202e and 202f and a femtocell management entity 206 that may coordinate operation of the plurality of femtocells, for example, femtocells 202a, 202b, 202c, 202d, 202e and 202f. The plurality of communication devices, for example, a plurality of cellular enabled communication devices 204a, 204b and 204c, and end-user communication devices 214a and 214b 204a, 204b, 204c, may be operable to communicate with one or more of the plurality of femtocells, for example, femtocells 202a, 202b, 202c, 202d, 202e and 202f via one or more wireless connections 205 and/or via one or more wired connections 207.

One of the plurality of communication devices, for example, communication device 204b, may comprise one or more circuits for use, and may be operable to receive information from the femtocell management entity 206 via one or both of the one or more wireless connections 205 and/or one or more wired connections 207. The one or more circuits in the communication device 204b may be operable to configure one of the plurality of communication devices, for example, the communication device 204b utilizing the received information. The one or more circuits in the communication device 204b may be operable to receive the information from the femtocell management entity 206 via one or more of the plurality of femtocells, for example, femtocell 202b. The one or more circuits in the communication device 204b may be operable to wirelessly receive the information from the femtocell management entity 206 via one or more of the plurality of femtocells, for example, femtocell 202b utilizing the one or more wireless connections 205. The one or more circuits in the communication device 204b may be operable to receive the information from the femtocell management entity 206 via one or more of the plurality of femtocells, for example, femtocell 202b utilizing the one or more wired connections 207. The one or more circuits in the communication device 204b may be operable to receive at least a portion of the information from the femtocell management entity 206 via one or more of said plurality of femtocells, for example, femtocell 202b utilizing the one or more wireless connections 205 and the one or more circuits in the communication device 204b may be operable to receive a remaining portion of the information from the femtocell management entity 206 via one or more of the plurality of femtocells, for example, femtocell 202b utilizing the one or more wired connections 207.

The received information may comprise one or more of software, service profiles, device configuration data and/or synchronization data, for example. Notwithstanding, the invention may not be so limited and other types of data may be received by the communication device without limiting the scope of the invention. The one or more circuits in the communication device 204b may be operable to synchronize the communication device 204b with one or more applications and/or services based on the received synchronization data. The one or more wireless connections 205 may be operable to convey the information wirelessly utilizing one or more standards comprising IS-95, CDMA, GSM, TDMA, GPRS, EDGE, UMTS, WCDMA, TD-SCDMA, OFDM and/or HSDPA cellular standards.

In accordance with another embodiment of the invention, one or more of the plurality of femtocells, for example, femtocell 202b may be operable to buffer the received information in the memory 160. The processor 158 in one or more of the plurality of femtocells, for example, femtocell 202b may be operable to communicate the buffered received information to the communication device 204b at a particular time, for example, during off-peak hours. The one or more circuits in the communication device 204b may be operable to receive the information upon installing and/or powering up of one or both of the communication device 204b and/or one or more of the plurality of femtocells, for example, femtocell 202b. The one or more circuits in the communication device 204b may be operable to receive the information upon command from a network administrator, for example, the femtocell management entity 206. The one or more circuits in the communication device 204b may be operable to receive the information when the communication device 204b is within a range of one or more of the plurality of femtocells, for example, femtocell 204b.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for remotely communicating information to a plurality of devices within a femtocell network.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. In a communication system comprising a plurality of communication devices operable to communicate with one or more of a plurality of femtocells via one or more wireless connections and/or via one or more wired connections, wherein said femtocells are managed via a femtocell management entity, a method for communication, the method comprising:
receiving by one of said plurality of communication devices, information from said femtocell management entity via one or both of said one or more wireless connections and/or said one or more wired connections; and
configuring said one of said plurality of communication devices utilizing said received information.

2. The method according to claim 1, comprising receiving said information from said femtocell management entity via said one or more of said plurality of femtocells.

3. The method according to claim 2, comprising wirelessly receiving said information from said femtocell management entity via said one or more of said plurality of femtocells utilizing said one or more wireless connections.

4. The method according to claim 2, comprising receiving said information from said femtocell management entity via said one or more of said plurality of femtocells utilizing said one or more wired connections.

5. The method according to claim 2, comprising:
receiving at least a portion of said information from said femtocell management entity via said one or more of said plurality of femtocells utilizing said one or more wireless connections; and.
receiving a remaining portion of said information from said femtocell management entity via said one or more of said plurality of femtocells utilizing said one or more wired connections.

6. The method according to claim 1, wherein said received information comprises one or more of: software, service profiles, device configuration data and/or synchronization data.

7. The method according to claim 6, comprising synchronizing said communication device with one or more applications and/or services based on said received synchronization data.

8. The method according to claim 1, wherein said one or more wireless connections is operable to convey said information wirelessly utilizing one or more standards comprising IS-95, CDMA, GSM, TDMA, GPRS, EDGE, UMTS, WCDMA, TD-SCDMA, OFDM and/or HSDPA cellular standards.

9. The method according to claim 1, wherein said one or more of said plurality of femtocells buffers said received information.

10. The method according to claim 9, wherein said one or more of said plurality of femtocells communicates said buffered said received information to said communication device at a particular time.

11. The method according to claim 1, comprising receiving said information upon installing and/or powering up of one or both of: said communication device and/or said one or more of said plurality of femtocells.

12. The method according to claim 1, comprising receiving said information upon command from a network administrator.

13. The method according to claim 1, comprising receiving said information when said communication device is within a range of said one or more of said plurality of femtocells.

14. In a communication system comprising a plurality of communication devices operable to communicate with one or more of a plurality of femtocells via one or more wireless connections and/or via one or more wired connections, wherein said femtocells are managed via a femtocell management entity, a system for communication, the system comprising:
one or more circuits for use in one of said plurality of communication devices, wherein said one or more circuits is operable to receive information from said femtocell management entity via one or both of said one or more wireless connections and/or said one or more wired connections; and
said one or more circuits is operable to configure said one of said plurality of communication devices utilizing said received information.

15. The system according to claim 14, wherein said one or more circuits is operable to receive said information from said femtocell management entity via said one or more of said plurality of femtocells.

16. The system according to claim 15, wherein said one or more circuits is operable to wirelessly receive said information from said femtocell management entity via said one or more of said plurality of femtocells utilizing said one or more wireless connections.

17. The system according to claim 15, wherein said one or more circuits is operable to receive said information from said femtocell management entity via said one or more of said plurality of femtocells utilizing said one or more wired connections.

18. The system according to claim 15, wherein:
said one or more circuits is operable to receive at least a portion of said information from said femtocell management entity via said one or more of said plurality of femtocells utilizing said one or more wireless connections; and.
said one or more circuits is operable to receive a remaining portion of said information from said femtocell management entity via said one or more of said plurality of femtocells utilizing said one or more wired connections.

19. The system according to claim 14, wherein said received information comprises one or more of: software, service profiles, device configuration data and/or synchronization data.

20. The system according to claim 19, wherein said one or more circuits is operable to synchronize said communication device with one or more applications and/or services based on said received synchronization data.

21. The system according to claim 14, wherein said one or more wireless connections is operable to convey said information wirelessly utilizing one or more standards comprising IS-95, CDMA, GSM, TDMA, GPRS, EDGE, UMTS, WCDMA, TD-SCDMA, OFDM and/or HSDPA cellular standards.

22. The system according to claim 14, wherein said one or more of said plurality of femtocells buffers said received information.

23. The system according to claim 22, wherein said one or more of said plurality of femtocells communicates said buffered said received information to said communication device at a particular time.

24. The system according to claim 14, wherein said one or more circuits is operable to receive said information upon installing and/or powering up of one or both of: said communication device and/or said one or more of said plurality of femtocells.

25. The system according to claim 14, wherein said one or more circuits is operable to receive said information upon command from a network administrator.

26. The system according to claim 14, wherein said one or more circuits is operable to receive said information when said communication device is within a range of said one or more of said plurality of femtocells.
